(19) United States
(12) Patent Application Publication
(10) Pub. No.: US 2017/0327626 A1
(43) Pub. Date: Nov. 16, 2017

(54) METHOD FOR PRODUCING RADIATION-CURABLE URETHANE (METH)ACRYLATES

(71) Applicant: BASF SE, Ludwigshafen (DE)

(72) Inventors: Sebastian Roller, Mannheim (DE); Christina Haaf-Kleinhubbert, Hemsbach (DE); Manfred Biehler, Ilbesheim (DE)

(21) Appl. No.: 15/520,863

(22) PCT Filed: Oct. 16, 2015
(86) PCT No.: PCT/EP2015/073954

§ 371 Date: Apr. 21, 2017

(30) Foreign Application Priority Data
Oct. 28, 2014 (EP) 14190673.5

(51) Int. Cl. C08G 18/67; C08G 18/80; C08G 18/48; C09D 175/16; C08G 18/22

(52) U.S. Cl. CPC C08G 18/6795; C09D 175/16; C08G 18/227; C08G 18/4883; C08G 18/8058

(57) ABSTRACT

Disclosed are urethane (meth)acrylates obtainable by implementation of the following steps:
(r1) partially reacting an alkoxylated polyol (A) with (meth)acrylic acid (B) in the presence of at least one esterification catalyst (C) and at least one polymerization inhibitor (D) and also, optionally, of a solvent (E) that forms an azeotrope with water,
   (o1) optionally removing at least some of the water formed in r1) from the reaction mixture, it being possible for o1) to take place during and/or after r1),
   (o2) optionally neutralizing the reaction mixture,
   (o3) if a solvent (E) has been used, optionally removing this solvent by distillation and/or
   (o4) stripping with a gas which is inert under the reaction conditions,
(r2) reacting the reaction mixture obtained after the last of the above reaction steps with a compound (G) containing at least two epoxy groups, optionally in the presence of a catalyst (H), and
(r3) reacting the reaction mixture from (r2) with at least one polyisocyanate (J) and at least one hydroxyalkyl (meth)acrylate (K) and optionally with at least one further compound (M) which contains one or more isocyanate-reactive groups, in the presence of a catalyst (L),
with the proviso that the catalyst (L) used in step (r3) is a bismuth-containing catalyst.

### FIELD OF THE INVENTION

The invention relates to a process for preparing radiation-curable urethane (meth)acrylates, to the urethane (meth)acrylates obtainable by this process, and to their use.

### PRIOR ART

Radiation-curable compounds are increasingly being used as coating systems for various substrates.

EP-B-1,576,027 describes an essentially 3-step process for preparing radiation-curable urethane (meth)acrylates. Obligatory steps in that process are steps (a), (k), and (l) as described in that patent specification.

### DESCRIPTION OF THE INVENTION

It was an object of the present invention to provide one-component, radiation-curable urethane (meth)acrylates which are distinguished by high levels of abrasion resistance, combined toughness and resilience, and chemical resistance. In particular, the parameters of abrasion resistance and storage stability ought to be improved in comparison to the corresponding systems known from the prior art.

A subject of the invention is a radiation-curable urethane (meth)acrylate obtainable by implementation of the following steps:
(r1) partially reacting an alkoxylated polyol (A) with (meth)acrylic acid (B) in the presence of at least one esterification catalyst (C) and at least one polymerization inhibitor (D) and also, optionally, of a solvent (E) that forms an azeotrope with water,
   (o1) optionally removing at least some of the water formed in r1) from the reaction mixture, it being possible for o1) to take place during and/or after r1),
   (o2) optionally neutralizing the reaction mixture,
   (o3) if a solvent (E) has been used, optionally removing this solvent by distillation and/or
   (o4) stripping with a gas which is inert under the reaction conditions,
(r2) reacting the reaction mixture obtained after the last of the above reaction steps with a compound (G) containing at least two epoxy groups, optionally in the presence of a catalyst (H), and
(r3) reacting the reaction mixture from (r2) with at least one polyisocyanate (J) and at least one hydroxyalkyl (meth)acrylate (K) and optionally with at least one further compound (M) which contains one or more isocyanate-reactive groups, in the presence of a catalyst (L),
with the proviso that the catalyst (L) used in step (r3) is a bismuth-containing catalyst.

For clarity, the following is noted: of the steps indicated, steps (r1), (r2), and (r3) are the three key steps in the preparation of the radiation-curable urethane (meth)acrylates of the invention, and each constitute chemical reactions.

A further subject of the invention is a process for preparing a radiation-curable urethane (meth)acrylate obtainable by implementing the following steps:
(r1) partially reacting an alkoxylated polyol (A) with (meth)acrylic acid (B) in the presence of at least one esterification catalyst (C) and at least one polymerization inhibitor (D) and also, optionally, of a solvent (E) that forms an azeotrope with water,
   (o1) optionally removing at least some of the water formed in r1) from the reaction mixture, it being possible for o1) to take place during and/or after r1),
   (o2) optionally neutralizing the reaction mixture,
   (o3) if a solvent (E) has been used, optionally removing this solvent by distillation and/or
   (o4) stripping with a gas which is inert under the reaction conditions,
(r2) reacting the reaction mixture obtained after the last of the above reaction steps with a compound (G) containing at least two epoxy groups, optionally in the presence of a catalyst (H), and
(r3) reacting the reaction mixture from (r2) with at least one polyisocyanate (J) and at least one hydroxyalkyl (meth)acrylate (K) and optionally with at least one further compound (M) which contains one or more isocyanate-reactive groups, in the presence of a catalyst (L),
with the proviso that the catalyst (L) used in step (r3) is a bismuth-containing catalyst.

Surprisingly it has emerged that urethane methacrylates obtained by the process of the invention using the specific catalyst (L) in step (r3), this being a bismuth-containing catalyst, fulfil the above-stated objectives in every respect, and exhibit a very considerably improved abrasion resistance and storage stability as compared with the urethane (meth)acrylates according to the disclosure in the above-cited EP-B-1,576,027.

### Step (r1)

Details are given below of reaction step (r1). They include observations on components (A), (B), (C), (D), and (E), and additionally on optional steps (o1), (o2), (o3), (o4).

The term (meth)acrylic acid or (meth)acrylic ester stands in this specification for methacrylic acid and acrylic acid and, respectively, for methacrylic ester and acrylic ester. Preferred in accordance with the invention is acrylic acid.

The compounds (A) are alkoxylated polyols. Further details are given below of the polyols on which the compounds (A) are based. Details are likewise given concerning the compounds (A).

The alkoxylated polyols (A) for inventive use are compounds containing at least two hydroxyl functions (—OH) per molecule. In one embodiment the alkoxylated polyols (A) contain three to ten, preferably three to six, and more particularly three to four OH functions per molecule. Especially preferred are those alkoxylated polyols (A) which contain three OH functions per molecule.

The polyols on which the compounds (A) are based may be aliphatic, cycloaliphatic or aromatic, preferably aliphatic or cycloaliphatic, and very preferably aliphatic, linear or branched, and optionally substituted by functional groups.

In general the polyols on which the compounds (A) are based have 4 to 50 carbon atoms, preferably 5 to 40, more preferably 6 to 30, and very preferably 8 to 26.

The molar weight of the polyols on which the compounds (A) are based is generally, unless otherwise indicated, below 2500 g/mol, preferably below 2000 g/mol, more preferably 106-1500 g/mol, very preferably 150-1200 g/mol, and more particularly 170-1050 g/mol. The polydispersity M_{w}:Mₙ is generally from 1 to 5, preferably from 1 to 3.

The polyols on which the compounds (A) are based may carry functional groups or may be unfunctionalized; preferably, they carry no further functional groups.

Examples of suitable polyols on which the compounds (A) are based are trimethylolbutane, trimethylolpropane, trimethylolethane, neopentyl glycol, neopentyl glycol hydroxypivalate, pentaerythritol, glycerol, 1,2-ethylene glycol, 1,2-propylene glycol, 1,3-propanediol, 2-ethyl-1,3-propanediol, 2-methyl-1,3-propanediol, hydroquinone, bisphenol A, bisphenol F, bisphenol B, 2,2-bis(4-hydroxycyclohexyl)propane, 1,1-, 1,2-, 1,3-, and 1,4-cyclohexanedimethanol, 1,2-, 1,3- or 1,4-cyclohexanediol, but-2-ene-1,4-diol, and but-2-yne-1,4-diol.

The polyols on which the compounds (A) are based may also carry additional functional groups such as, for example, ether functions (—O—), carboxyl functions (—COOH) or C₁-₆-alkyloxycarbonyl functions (ester groups), with “C₁₋₆-alkyl-” embracing the radicals methyl, ethyl, isopropyl, n-propyl, n-butyl, isobutyl, sec-butyl, tent-butyl, n-pentyl, isopentyl, neopentyl, n-hexyl, isohexyl or neohexyl.

Examples of such functionalized polyols are ditrimethylolpropane, dipentaerythritol, dimethylolpropionic acid, dimethylolbutyric acid, trimethylolacetic acid, hydroxypivalic acid, and the 2-hydroxyethyl or C₁-₄-alkyl esters of these stated acids, with “C₁-₄-alkyl-” embracing the radicals methyl, ethyl, isopropyl, n-propyl, n-butyl, isobutyl, sec-butyl, and tent-butyl.

Particularly preferred polyols are those of the formula (I):

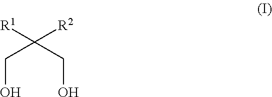

In this formula
R¹, R² independently of one another are hydrogen, C₁₋₁₀-alkyl, preferably C₁₋₄-alkyl, C₁₋₁₀-hydroxyalkyl, preferably C₁₋₄-hydroxyalkyl, carboxyl or C₁₋₄-alkyloxycarbonyl, preferably hydrogen, hydroxymethyl, and C₁₋₄-alkyl, and more preferably hydroxymethyl and C₁₋₄-alkyl.

The alkyl radicals here may each be linear or branched.

Examples of R1 and R2 are hydrogen, methyl, ethyl, isopropyl, n-propyl, n-butyl, isobutyl, sec-butyl, tent-butyl, n-pentyl, n-hexyl, n-heptyl, n-octyl, n-decyl, hydroxymethyl, carboxyl, methoxycarbonyl, ethoxycarbonyl or n-butoxycarbonyl.

The radicals R¹ and R² are preferably selected from the group consisting of hydrogen, hydroxymethyl, methyl, and ethyl, and more particularly from the group consisting of hydroxymethyl, methyl and ethyl.

Particularly preferred polyhydric alcohols of the formula (I) are trimethylolbutane, trimethylolpropane, trimethylolethane, neopentyl glycol, pentaerythritol, 2-ethyl-1,3-propanediol, 2-methyl-1,3-propanediol, 1,3 -propanediol, dimethylolpropionic acid, methyl dimethylolpropionate, ethyl dimethylolpropionate, dimethylolbutyric acid, methyl dimethylolbutyrate or ethyl dimethylolbutyrate.

The compounds of the formula (I) are preferably selected from the group consisting of neopentyl glycol, trimethylolpropane, pentaerythritol, and dimethylolpropionic acid.

Especially preferred is the selection of the compounds of the formula (I) from the group consisting of neopentyl glycol, trimethylolpropane, and pentaerythritol, and more particularly trimethylolpropane and pentaerythritol.

Examples of sugar alcohols as polyols are sorbitol, mannitol, maltitol, isomalt, diglycerol, threitol, erythritol, adonitol (ribitol), arabitol (lyxitol), xylitol, and dulcitol (galactitol).

Alkoxylated polyols (A) in accordance with the invention are those obtainable by reacting a polyol with at least one alkylene oxide.

Preferred examples of such alkoxylated polyols (A) are the alkoxylation products (IIa), (IIb) or (IIc) of polyols of the formula (I),

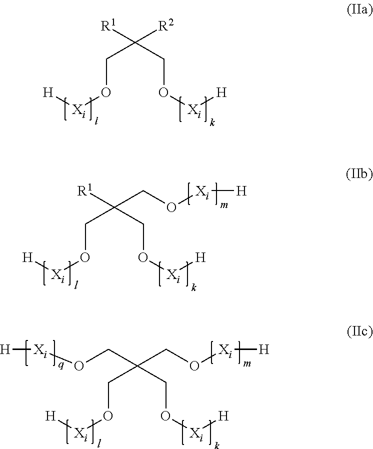

in which
R¹ and R² have the definitions stated above in formula (I),
k, l, m, and q independently of one another are each an integer from 0 to 10, preferably 2 to 7, more preferably 3 to 6, and more particularly 5, and the sum of k+l+m+q is a number in the range from 1 to 20, and
each Xᵢ for i=I to k, 1 to l, 1 to m, and 1 to q may be selected independently of any other from the group consisting of CH₂CH₂O, CH₂CH(CH₃)O, CH(CH₃)CH₂O, CH₂C(CH₃)₂O, C(CH₃)₂CH₂O, CH₂CH(Vin)O, CHVinCH₂O, CH₂CH(Ph)O, and CH(Ph)CH₂O, preferably from the group consisting of CH₂CH₂O, CH₂CH(CH₃)O, and CH(CH₃)CH₂O, and more preferably CH₂CH₂O, where (Ph) is phenyl and (Vin) is vinyl.

It is expressly noted that the details for the building blocks Xᵢ may not be interpreted to mean that start and end of these building blocks can be combined arbitrarily with one another. For instance, it would be unallowable for two CH₂CH₂O building blocks, for instance, to be linked in such a way as to form a CH₂CH₂OOCH₂CH₂ moiety. It is clear to the skilled person, rather, that the formulae (IIa), (IIb) or (IIc) describe alkoxylation products.

Among these, the compounds of the formula (IIb) are particularly preferred.

The alkoxylation products (IIa), (IIb) or (IIc) preferably comprise singly to 20-tuply, more preferably 5- to 20-tuply, very preferably 10-20-tuply, and more particularly 12-20-tuply ethoxylated, propoxylated, or mixedly ethoxylated and propoxylated, and more particularly exclusively ethoxylated, trimethylolpropane, trimethylolethane or pentaerythritol.

The stated degrees of alkoxylation are based in each case on the average degree of alkoxylation, and so statistically there may also be nonintegral degrees of alkoxylation.

The data relating to the number-average and weight-average molecular weights Mₙ and M_{w} are based on gel permeation chromatography measurements using polystyrene as standard and tetrahydrofuran as eluent. The method is described in Analytiker Taschenbuch vol. 4, pages 433 to 442, Berlin 1984.

The polydispersity M_{w}/Mₙ, the ratio of the weight-average to the number-average molecular weight of the alkoxylated polyols (A), represents a measure of the molecular weight distribution and in an ideal case has a value of 1, though for practical purposes values below 4.0, preferably below 3.5, are generally sufficient.

Examples of alkoxylated sugar alcohols are those compounds which are obtainable from sugar alcohols—for example, from the sugar alcohols listed above—by alkoxylation, with, for example, the above-recited alkylene oxides, preferably with ethylene oxide and/or propylene oxide, and very preferably with ethylene oxide.

Examples thereof are
the recited tetrols, which on statistical average are 2-30-tuply, preferably 2-20-tuply, more preferably 3-10-tuply, and more particularly 3-, 4-, 5-, 6-, 7- or 8-tuply alkoxylated per mole of sugar alcohol,
the recited pentols, which on statistical average are 3-35-tuply, preferably 3-28-tuply, more preferably 4-20-tuply, and more particularly 4-, 5-, 6-, 7-, 8-, 9- or 10-tuply alkoxylated per mole of sugar alcohol,
higher sugar alcohols, which on statistical average are 4-50-tuply, preferably 6-40-tuply, more preferably 7-30-tuply, very preferably 8-20-tuply, and more particularly 10-15-tuply alkoxylated per mole of sugar alcohol.

Alkoxylations, in other words the reaction of mono- or polyhydric alcohols with alkylene oxides, are very familiar indeed to the skilled person. In such reactions, customarily, the corresponding alcohol is reacted at elevated temperature with the desired amount of an alkylene oxide, in the presence of a catalyst.

Where alcohols with mixed alkoxylation are used, the different alkoxy groups they contain may have a molar ratio to one another of, for example, 0.05-20:1, preferably 0.1-10:1, and more preferably 0.2-5:1.

The viscosity of the alkoxylated polyols (A) for inventive use is not subject to any particular requirements, other than that said polyols should be readily pumpable at a temperature of up to about 80° C.; preferably they ought to have a viscosity below 2000 mPas, preferably below 1500 mPas, and very preferably below 1000 mPas at 60° C.

As indicated above, (meth)acrylic acid (B) comprehends methacrylic acid or acrylic acid. Acrylic acid is preferred as compound (B).

In one embodiment the molar ratio of alkoxylated polyol (A):(meth)acrylic acid (B) in the esterification is 1:0.75 to 2.5 and preferably 1:0.8 to 2. A ratio of 1:0.9 to 1.5 and more particularly 1:1-1.2 is particularly preferred.

For the esterification it is possible to employ all processes relevantly known to the skilled person.

Esterification catalysts (C) are preferably sulfuric acid, aryl- or alkylsulfonic acids, or mixtures thereof. Examples of arylsulfonic acids are benzenesulfonic acid, para-toluenesulfonic acid or dodecylbenzenesulfonic acid. Examples of alkylsulfonic acids are methanesulfonic acid, ethanesulfonic acid or trifluoromethanesulfonic acid. Strongly acidic ion exchangers or zeolites as well can be used as esterification catalysts. Preferred are para-toluenesulfonic acid, sulfuric acid, and ion exchangers.

They are used in general in an amount of 0.1-5 wt %, based on the esterification mixture, preferably 0.15-5, more preferably 0.2-4, and very preferably 0.25-3 wt %.

If necessary, the esterification catalyst (C) can be removed from the reaction mixture using an ion exchanger. The ion exchanger in this case may be added directly to the reaction mixture and removed subsequently by filtration, or the reaction mixture may be passed through an ion exchanger bed.

Preferably the esterification catalyst (C) is left in the reaction mixture. Where, however, the catalyst is an ion exchanger, it is preferably removed, by filtration, for example.

Polymerization inhibitors (D) which can be used are, for example, hydroquinone, hydroquinone monomethyl ether, 2,5-di-t-butylhydroquinone, 2,6-di-t-butyl-p-cresol, nitroso compounds, such as isoacryloyl nitrite, nitrosodiphenylamine or N-nitrosocyclohexylhydroxylamine, methylene blue, phenothiazine, tannic acid or diphenylamine. In the context of the present invention it is also possible for two or more of these polymerization inhibitors to be used together. The polymerization inhibitors are used preferably in amounts of 1 to 10 000 ppm, more particularly in amounts of 100 to 1000 ppm, based in each case on the overall batch.

Additionally suitable as polymerization inhibitors are phenolic compounds, amines, nitro compounds, phosphorus-containing or sulfur-containing compounds, hydroxylamines, and N-oxyls, and also, optionally, mixtures thereof.

Preferred polymerization inhibitors are those from the group of phenothiazine, N-oxyls, and phenolic compounds.

N-Oxyls (nitroxyl or N-oxyl radicals, compounds which have at least one NO group) are, for example, 4-hydroxy-2,2,6,6-tetramethylpiperidine N-oxyl or 4-oxo-2,2,6,6-tetramethylpiperidine N-oxyl.

Phenolic compounds are, for example, alkylphenols, as for example 2-tert-butyl-4-methylphenol, 6-tert-butyl-2,4-dimethylphenol, 2,6-di-tert-butyl-4-methylphenol, pyrocatechol (1,2-dihydroxybenzene), bisphenol A, bisphenol F, bisphenol B, Koresin® from BASF AG, Irganox® 565, 1141, 1192, 1222, and 1425 from Ciba Spezialitätenchemie, aminophenols, such as para-aminophenol, nitrosophenols, such as para-nitrosophenol, alkoxyphenols, as for example 2-methoxyphenol (guaiacol, pyrocatechol monomethyl ether), 2-ethoxyphenol, 2-isopropoxyphenol, 4-methoxyphenol (hydroquinone monomethyl ether), tocopherols, quinones and hydroquinones such as, for example, hydroquinone, 2,5-di-tert-butylhydroquinone, benzoquinone, p-phenoxyphenol, anthraquinone or 2,5-di-tert-amylhydroquinone.

Aromatic amines are, for example, N,N-diphenylamine; phenylenediamines are, for example, N,N′-dialkyl-para-phenylenediamine, as for example N,N′-di-sec-butyl-para-phenylenediamine; hydroxylamines are, for example, N,N-diethylhydroxylamine; phosphorus-containing compounds are, for example, triphenylphosphine, triphenyl phosphite or triethyl phosphite; and sulfur-containing compounds are, for example, diphenyl sulfide.

Preferred are phenothiazine, p-aminophenol, p-nitrosophenol, 2-tert-butylphenol, 4-tert-butylphenol, 2,4-di-tert-butylphenol, 2-methyl-4-tert-butylphenol, 4-tent-butyl-2,6-dimethyl-phenol, hydroquinone and/or hydroquinone monomethyl ether, and N,N′-di-sec-butyl-para-phenylenediamine.

Especially preferred are phenothiazine, hydroquinone monomethyl ether, and mixtures thereof.

Moreover it is possible to use phosphorus-containing compounds, such as triphenylphosphine, triphenyl phosphite, hypophosphorous acid or triethyl phosphite, for example, optionally in combination with metal salts, such as, for example, the chlorides, dithiocarbamates, sulfates, salicylates or acetates of copper, manganese, cerium, nickel or chromium.

There is no restriction on the way in which the polymerization inhibitor is added. The added polymerization inhibitor may be added in each case individually or as a mixture, in a liquid form or in a form in solution in a suitable solvent, in which case the solvent itself may be a polymerization inhibitor.

Where a mixture of two or more polymerization inhibitors is used, they may also be dissolved independently of one another in different solvents.

The polymerization inhibitor (mixture) (D) is used preferably in a total amount of 0.01-1 wt %, based on the esterification mixture, more preferably 0.02-0.8, very preferably 0.05-0.5 wt %.

For further support of the stabilization, an oxygen-containing gas, preferably air or a mixture of air and nitrogen (lean air), may be present.

Solvents (E) which can be used in accordance with the invention are especially those suitable for azeotropic removal of the water of reaction, if desired; in particular, aliphatic, cycloaliphatic, and aromatic hydrocarbons or mixtures thereof.

Employed with preference are n-pentane, n-hexane, n-heptane, cyclohexane, methylcyclohexane, benzene, toluene or xylene. Particularly preferred are cyclohexane, methylcyclohexane, and toluene.

With regard to optional step (o1)—viz the removal of the water of reaction—the following is the case: the water of reaction formed in the course of the reaction in step (r1), the esterification of alkoxylated polyol (A) with (meth)acrylic acid (B), may be removed by distillation during or after the esterification, and this distillation procedure may be assisted by means of a solvent that forms an azeotrope with water. The major part of the water formed during the esterification in step (r1) is preferably removed. Solvents (E) suitable for the azeotropic removal of the water of reaction are the compounds listed above.

Esterification in the presence of a solvent is preferred in the course of step (r1).

The amount of solvent used in this case is in particular 5-100 wt %, preferably 10-100 wt %, more preferably 15 to 100 wt %, based on the sum total of polyalcohol and carboxylic acid (B).

If the water present in the reaction mixture is not removed via an azeotrope-forming solvent, then it may if desired be removed via stripping with an inert gas, preferably an oxygen-containing gas such as air or lean air.

In one embodiment the reaction temperature for the esterification r1) is set at levels in the range of 40-160° C., preferably 60-140° C., and more preferably 80-120° C. Over the course of the reaction the temperature may remain the same or rise; preferably it is raised over the course of reaction. In that case the final temperature of the esterification is higher by 5-30° C. than the initial temperature. If a solvent is used, it can be removed by distillation from the reaction mixture, using the distillation unit mounted on the reactor. The distillate may alternatively be removed or, after condensation, passed into a phase separation apparatus. The esterification may be carried out unpressurized or else at superatmospheric or subatmospheric pressure; preference is given to operation under standard pressure. The reaction time is generally 2-20 hours, preferably 4-17, and more preferably 7 to 15 hours.

The sequence in which the individual reaction components are added in the esterification (r1) is not critical to the invention. A mixture of all of the components may be introduced and subsequently heated, or one or more components may not be introduced initially, or may be introduced initially only in part, and may be added only after heating has taken place.

The course of the esterification (r1) may be followed by monitoring the amount of water discharged and/or the decrease in the concentration of (meth)acrylic acid in the reactor.

The reaction may be ended, for example, as soon as 75% of the theoretically anticipated quantity of water has been discharged through the solvent, preferably at not less than 80% and more preferably at not less than 85%.

It is also possible at least partially not to remove the water of reaction. In that case a substantial part of the quantity of water formed remains in the reaction mixture. During or after the reaction, the only fraction of water removed from the reaction mixture is that which is determined by the volatility at the applied temperature, and no measures beyond this are carried out for removing the water of reaction formed. Thus, for example, at least 10 wt % of the water of reaction formed may remain in the reaction mixture, preferably at least 20 wt %, more preferably at least 30 wt %, very preferably at least 40, and more particularly at least 50 wt %.

After the end of the esterification (r1), the reactor mixture may be cooled conventionally to a temperature in the range from 10 to 30° C. and optionally a desired target ester concentration may be brought about by addition of solvent, which may be the same as or different from the solvent optionally used for the azeotropic removal of water.

If necessary, the reaction mixture (r1) may be subjected to decolorizing, by means for example of treatment with activated carbon or metal oxides, such as aluminum oxide, silicon oxide, magnesium oxide, zirconium oxide, boron oxide or mixtures thereof, for example, in amounts for example of 0.1-50 wt %, preferably 0.5 to 25 wt %, more preferably 1-10 wt %, at temperatures of, for example, 10 to 100° C., preferably 20 to 80° C., and more preferably 30 to 60° C.

This may be accomplished by adding the decolorizing agent in powder or granule form to the reaction mixture, with subsequent filtration, or by passing the reaction mixture over a bed of the decolorizing agent in the form of any desired suitable shaped bodies.

The reaction mixture may be decolorized at any desired point in the workup process, as for example at the stage of the crude reaction mixture or after optional preliminary washing, neutralization, washing or removal of solvent.

The reaction mixture obtained in step (r1) may if desired be subjected to a preliminary wash (o5) and/or a neutralization o2) and/or a subsequent wash (o6), preferably just to a neutralization (o2). If desired, the order of neutralization (o2) and preliminary wash (o5) may be reversed.

For the preliminary or subsequent wash (o5) or (o6), the reaction mixture is treated in a scrubber with a wash liquid, as for example water or a 5-30 wt % strength, preferably 5-20, more preferably 5-15 wt % strength sodium chloride, potassium chloride, ammonium chloride, sodium sulfate or ammonium sulfate solution, preferably water or sodium chloride solution. The quantitative reaction mixture:wash liquid ratio is generally 1:0.1-1, preferably 1:0.2-0.8, more preferably 1:0.3-0.7.

Washing or neutralization may be carried out, for example, in a stirred tank or in other conventional apparatus, as for example in a column or mixer-settler apparatus.

Preliminary washing (o5) is employed preferentially when metal salts, preferably copper or copper salts, are (among those) used as inhibitors.

A subsequent wash (o6) may be advantageous for removing traces of base or of salt from the reaction mixture neutralized in (o2).

For the neutralization (o2), the optionally prewashed reaction mixture, which may still contain small amounts of catalyst and the major amount of excess (meth)acrylic acid (B), may be neutralized with a 5-25, preferably 5-20, more preferably 5-15 wt % strength aqueous solution of a base, such as, for example, alkali metal or alkaline earth metal oxides, hydroxides, carbonates or hydrogencarbonates, preferably sodium hydroxide, potassium hydroxide, sodium hydrogencarbonate, sodium carbonate, potassium hydrogencarbonate, calcium hydroxide, milk of lime, ammonia, aqueous ammonia or potassium carbonate, to which optionally 5-15 wt % of sodium chloride, potassium chloride, ammonium chloride or ammonium sulfate may have been added; neutralization takes place more preferably with aqueous sodium hydroxide solution or sodium hydroxide/sodium chloride solution. The degree of neutralization is preferably 5 to 60 mol %, more preferably 10 to 40 mol %, very preferably 20 to 30 mol %, based on the monomers containing acid groups.

The base is added in a manner such that the temperature in the apparatus does not rise beyond 60° C., being preferably between 20 and 35° C., and the pH is 4-13. The heat of neutralization is dissipated preferably by cooling of the container by means of internal cooling coils or via jacket cooling.

The quantitative reaction mixture:neutralizing liquid ratio is generally 1:0.1-1, preferably 1:0.2-0.8, more preferably 1:0.3-0.7.

If a solvent is present in the reaction mixture, it can be removed substantially by distillation. Preferably any solvent present is removed from the reaction mixture after washing and/or neutralization; if desired, however, this removal may also take place prior to the washing and/or neutralization.

For this purpose, the reaction mixture can be admixed with a storage stabilizer, preferably hydroquinone monomethyl ether, in an amount such that following removal of the solvent, there are 100-500, preferably 200-500, and more preferably 200-400 ppm thereof present in the target ester (residue).

The distillative removal of the major amount of solvent is accomplished, for example, in a stirred tank with jacket heating and/or with internal heating coils, under reduced pressure, as for example at 20-700 mbar, preferably 30 to 500 and more preferably 50-150 mbar, at a temperature of 40-120° C.

Distillation may of course also take place in a falling-film or thin-layer evaporator. For that purpose the reaction mixture is passed through the apparatus, preferably repeatedly in a circuit, under reduced pressure, as for example at 20-700 mbar, preferably 30 to 500, and more preferably 50-150 mbar, at a temperature of 40-80° C.

An inert gas, preferably an oxygen-containing gas, more preferably air or a mixture of air and nitrogen (lean air), may advantageously be introduced into the distillation apparatus—for example, 0.1-1, preferably 0.2-0.8, and more preferably 0.3-0.7 m³ of oxygen-containing gas per m³ of reaction mixture per hour.

The residual solvent content of the residue after the distillation is generally below 5 wt %, preferably 0.5-5%, and more preferably 1 to 3 wt %.

The solvent removed is condensed and preferably reused.

If necessary, in addition to or instead of the distillation, solvent stripping (o4) may be carried out.

For this purpose, the target ester, still containing small amounts of solvent, is heated to 50-90° C., preferably 80-90° C., and the remaining amounts of solvent are removed with a suitable gas in a suitable apparatus. For support, optionally, a reduced pressure may also be applied.

Suitable gases are gases which are inert under the conditions of stripping, preferably oxygen-containing gases, more preferably air or mixtures of air and nitrogen (lean air) or steam, more particularly mixtures which are conditioned to a temperature of 50 to 100° C.

The amount of stripping gas is for example 5-20, more preferably 10-20, and very preferably 10 to 15 m³ of stripping gas per cubic meter of reaction mixture per hour.

Excess (meth)acrylic acid is removed from the reaction mixture by distillation, optionally under reduced pressure.

If desired, the esterification mixture may be subjected to filtration (o7) at any desired stage in the workup process, preferably after washing/neutralization and, optionally removal of solvent, in order to remove precipitated traces of salts and also any decolorizing agent present.

In one embodiment the esterification catalyst (C) used remains essentially in the reaction mixture.

In one embodiment there is no preliminary washing (o5), subsequent washing (o6) or neutralization (o2).

The reaction mixture resulting from step (r1) generally has an acid number—determined to DIN EN 3682—of up to 200 mg KOH/g, preferably of 5 to 100, more preferably of 5 to 50, and very preferably of 5 to 30 mg KOH/g, and an OH number—determined to DIN 53240—of up to 120 mg KOH/g, preferably of 10 to 100, more preferably of 15 to 70, and very preferably of 20 to 90 mg KOH/g.

The reaction mixture resulting from step (r1) contains substantially 20 up to 80 wt % of fully esterified alkoxylated polyol (A), 20 to 50 wt % of unesterified or partially esterified alkoxylated polyol (A), 0.001 up to 25 wt % of unreacted (meth)acrylic acid (B), 0.1 to 5 wt % of esterification catalyst (C), and 0.01 to 1 wt % of polymerization inhibitor (D), and also, optionally, solvent(s) (E), with the proviso that the overall sum total is 100 wt %.

### Step (r2)

The reaction mixture obtained in step (r1)—optionally using one or more of abovementioned optional steps (o1) to (o7)—is reacted in a second step, referred to as step (r2), with a compound (G) containing at least two alkylene oxide units.

Epoxide compounds (G) for use are those having two or more epoxide groups per molecule. Compounds (G) having two epoxide groups per molecule are preferred.

Examples of those contemplated include glycidyl ethers of aliphatic or aromatic polyols. Products of this kind are available commercially in large numbers. Particularly preferred are polyglycidyl compounds of the bisphenol A, F or B type, their fully hydrogenated derivatives, and glycidyl ethers of polyhydric alcohols, as for example of 1,4-butanediol, 1,4-cyclohexanedimethanol, neopentyl glycol, 1,6-hexanediol, glycerol, trimethylolpropane, and pentaerythritol. Examples of such polyepoxide compounds are Epikote® 812 and Epikote® 828, Epikote® 1001, Epikote® 1007, and Epikote® 162 from Resolution Performance Products, Rütapox® 0162, Rütapox® 0164, and Rütapox® 0165 from Bakelite AG, and Araldit® DY 0397 from Vantico AG.

Especially preferred are bisphenol A diglycidyl ether, 1,4-butanediol diglycidyl ether, trimethylolpropane triglycidyl ether, and pentaerythritol tetraglycidyl ether, more particularly bisphenol A diglycidyl ether.

The epoxide compounds (G) are added to the reaction mixture from the esterification generally in amounts of 5-60 wt %, preferably 5-30 wt %, and more preferably 5-20 wt %, based on the reaction mixture (without solvent). Very preferably the epoxide compounds are used in approximately equimolar amounts, based on the acid equivalents still present in the reaction mixture—for example, an epoxide groups:acid groups ratio of 0.8-2.5:1, preferably 0.9-2.0:1, more preferably 1.0-1.5:1, and very preferably 1.0-1.2:1 mol/mol.

In the course of the reaction with the epoxide compounds (G), acid unreacted and/or employed in excess, more particularly (meth)acrylic acid, is bound in the form of epoxide ester.

The reaction with epoxide compounds takes place preferably at 90 to 130, more preferably at 100 to 110° C., and is continued until the reaction mixture has a DIN EN 3682 acid number of below 5, more preferably below 2 mg KOH/g (without solvent).

Step (r2) may be carried out if desired in the presence of catalysts (H).

Suitable compounds (H) are, for example, quaternary ammonium or phosphonium compounds, tertiary amines, phosphines such as triphenylphosphine, or Lewis bases such as thiodiglycol.

The catalysts (H) are used preferably in amounts of 0.01 to 5, more preferably of 0.1 to 3 wt %, based on the reaction mixture.

The temperature during reaction (r2) is set preferably at 40 to 130° C., more preferably 50 to 120, and very preferably 60 to 120° C.

The reaction mixture resulting from step (2) generally has a DIN EN 3682 acid number of below 5, preferably below 4 mg KOH/g, and a DIN 53240 OH number of up to 250 mg KOH/g, preferably up to 150, more preferably from 10 to 100, and very preferably from 20 to 90 mg KOH/g. It contains essentially from 20 up to 80 wt % of fully esterified polyol (A), 20 to 50 wt % of unesterified or partially esterified polyol (A), 0.001 up to 25 wt % of epoxidized, unesterified or partially esterified polyol (A), 0.1 to 15 wt % of epoxy esters of (meth)acrylic acid, esterification catalyst and polymerization inhibitor, traces of unreacted (meth)acrylic acid, and also, optionally, solvent(s), with the proviso that the overall sum total is 100 wt %.

### Step (r3)

The concluding reaction step (r3) takes place in the presence of a bismuth-containing catalyst (L). Specifically, in the concluding stage (r3), the reaction mixture from (r2) is treated by reacting the reaction mixture from (r2) with at least one polyisocyanate (J) and at least one hydroxyalkyl (meth)acrylate (K) and also, optionally, with at least one compound (M) having one or more isocyanate-reactive groups, in the presence of a bismuth-containing catalyst (L).

Bismuth (Latin: bisemutum) is, as is known, a chemical element having the elemental symbol Bi. Bismuth-containing catalysts are substances or mixtures of substances that contain bismuth. As far as the chemical structure of these substances is concerned per se, there are no restrictions. Both organic and inorganic bismuth compounds may be used as catalysts (L). Furthermore, mononuclear or polynuclear bismuth compounds may be used—that is, compounds where either one or two or more bismuth atoms are present per structural unit of the bismuth compound in question.

Bismuth-containing catalysts (L) contemplated include, preferably, bismuth compounds in the +3 oxidation state, especially with the following anions: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₓH₂ₓ₊₁)⁻, (CₓH₂ₓ₋₁O₂)⁻, (CₓH₂ₓ₋₃O₂)⁻, and also (Cₓ₊₁H₂ₓ₋₂O₄)²⁻, where x stands for the numbers 1 to 20. Catalysts (L) used in one embodiment are bismuth carboxylates, more particularly those having at least six carbon atoms, especially bismuth octoates, ethylhexanoates, neodecanoates, or pivalates; examples are K-KAT 348, XC-B221; XC-C227, XC 8203, and XK-601 from King Industries, TIB KAT 716, 716LA, 716XLA, 718, 720, and 789 from TIB Chemicals, and those from Shepherd Lausanne, and also, for example, Borchi® Kat 24; 315; 320 from OMG Borchers GmbH, Langenfeld, Germany.

Preferred catalysts (L) are bismuth(III) carboxylates in which the anion conforms to the formulae (CₓH₂ₓ₋₁O₂)⁻ and also (Cₓ₊₁H₂ₓ₋₂O₄)²⁻ with x being 1 to 20. Particularly preferred salts feature monocarboxylate anions of the general formula (CₓH₂ₓ₋₁O₂)⁻, where x stands for the numbers 1 to 20, preferably 1 to 10. Particularly noteworthy here are formate, acetate, propionate, hexanoate, neodecanoate, and 2-ethylhexanoate.

Particular preference is given to bismuth(III) neodecanoate and/or bismuth(III) 2-ethylhexanoate.

Examples of suitable polyisocyanate (J) are aliphatic, aromatic, and cycloaliphatic di- and polyisocyanates having an NCO functionality of at least 1.8, preferably 1.8 to 5, and more preferably 2 to 4, and also their isocyanurates, biurets, allophanates, and uretdiones.

The diisocyanates are preferably isocyanates having 4 to 20 C atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also aromatic diisocyanates such as 2,4- or 2,6-tolylene diisocyanate and isomer mixtures thereof, m- or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of the stated diisocyanates may also be present.

Preferred are 2,4- or 2,6-tolylene diisocyanate and isomer mixtures thereof, hexamethylene diisocyanate, 1,3-bis(isocyanatomethyl)cyclohexane, isophorone diisocyanate, and di(isocyanatocyclohexyl)methane.

Polyisocyanates contemplated include polyisocyanates containing isocyanurate groups, uretdione diisocyanates, polyisocyanates containing biuret groups, polyisocyanates containing urethane or allophanate groups, polyisocyanates containing oxadiazinetrione groups, uretonimine-modified polyisocyanates of linear or branched C₄-C₂₀-alkylene diisocyanates, cycloaliphatic diisocyanates having a total of 6 to 20 C atoms, or aromatic diisocyanates having a total of 8 to 20 C atoms, or mixtures thereof.

The di- and polyisocyanates which can be used preferably have an isocyanate group (calculated as NCO, molecular weight=42) content of 10 to 60 wt % based on the di- and polyisocyanate (mixture), preferably 15 to 60 wt %, and more preferably 20 to 55 wt %.

Preference is given to aliphatic and/or cycloaliphatic di- and polyisocyanates, examples being the abovementioned aliphatic and/or cycloaliphatic diisocyanates, or mixtures thereof.

Further preferred are:
1) isocyanurate group-containing polyisocyanates of aromatic, aliphatic and/or cycloaliphatic diisocyanates. Particularly preferred here are the corresponding aliphatic and/or cycloaliphatic isocyanato-isocyanurates, and especially those based on hexamethylene diisocyanate and isophorone diisocyanate. The isocyanurates present are, in particular, trisisocyanatoalkyl and/or trisisocyanatocycloalkyl isocyanurates, which represent cyclic trimers of the diisocyanates, or are mixtures with their higher homologs containing more than one isocyanurate ring. The isocyanato-isocyanurates generally have an NCO content of 10 to 30 wt %, more particularly 15 to 25 wt %, and an average NCO functionality of 3 to 4.5.
2) uretdione diisocyanates having aromatically, aliphatically and/or cycloaliphatically bonded isocyanate groups, preferably aliphatically and/or cycloaliphatically bonded groups, and more particularly those derived from hexamethylene diisocyanate or isophorone diisocyanate. Uretdione diisocyanates are cyclic dimerization products of diisocyanates. The uretdione diisocyanates may be used in the preparations of the invention as a sole component or in a mixture with other polyisocyanates, more particularly those identified under 1).
3) polyisocyanates containing biuret groups and having aromatically, cycloaliphatically or aliphatically bonded, preferably cycloaliphatically or aliphatically bonded, isocyanate groups, more particularly tris(6-isocyanatohexyl)biuret or its mixtures with its higher homologs. These polyisocyanates containing biuret groups generally have an NCO content of 18 to 22 wt % and an average NCO functionality of 3 to 4.5.
4) polyisocyanates containing urethane and/or allophanate groups and having aromatically, aliphatically or cycloaliphatically bonded, preferably aliphatically or cycloaliphatically bonded, isocyanate groups, as may be obtained, for example, by reaction of excess amounts of hexamethylene diisocyanate or of isophorone diisocyanate with polyhydric alcohols such as, for example, trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups generally have an NCO content of 12 to 20 wt % and an average NCO functionality of 2.5 to 3.
5) polyisocyanates containing oxadiazinetrione groups, derived preferably from hexamethylene diisocyanate or isophorone diisocyanate. Polyisocyanates of this kind containing oxadiazinetrione groups are preparable from diisocyanate and carbon dioxide.
6) uretonimine-modified polyisocyantes.

The polyisocyanates 1) to 6) may be used as a mixture, optionally also in a mixture with diisocyanates.

Hydroxyalkyl (meth)acrylates (K) contemplated include compounds which carry at least one, preferably 1 to 3, more preferably 1 to 2, and very preferably one hydroxyl group and at least one, preferably 1 to 3, more preferably 1 to 2, and very preferably one (meth)acrylate group.

Hydroxyalkyl (meth)acrylates (K) may for example be monoesters of (meth)acrylic acid with diols or polyols which have preferably 2 to 20 C atoms and at least two, preferably two, hydroxyl groups, such as ethylene glycol, diethylene glycol, triethylene glycol, 1,2-propylene glycol, 1,3-propylene glycol, 1,1 -dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, 1,6-hexanediol, 2-methyl-1,5-pentanediol, 2-ethyl-1,4-butanediol, 1,4-dimethylolcyclohexane, glycerol, trimethylolethane, trimethylolpropane, trimethylolbutane, pentaerythritol, ditrimethylolpropane, erythritol, sorbitol, polyTHF having a molar weight of between 162 and 378, poly-1,3-propanediol having a molar weight of between 134 and 400, or polyethylene glycol having a molar weight of between 238 and 458.

Suitable compounds (K) are, for instance: 2-hydroxyethyl (meth)acrylate, 2- or 3-hydroxypropyl (meth)acrylate, 1,4-butanediol mono(meth)acrylate, neopentyl glycol mono(meth)acrylate, glycerol mono- and di(meth)acrylate, trimethylolpropane mono- and di(meth)acrylate, and pentaerythritol mono-, di-, and tri(meth)acrylate.

Preference is given to selecting the compounds (K) from the following compounds: mono(meth)acrylic esters of ethoxylated trimethylolpropane, di(meth)acrylic esters of ethoxylated trimethylolpropane, butanediol diacrylate, bisphenol A diglycidyl diacrylate, butanediol diglycidyl ether diacrylate, mono-di-tri-acrylic esters of pentaerythritol tri/tetraepoxide. Butanediol diglycidyl ether diacrylate and bisphenol A diglycidyl diacrylate are particularly preferred as compounds (K).

If desired it is possible, optionally, for compounds (M) to be added during or after the end of the reaction of the reaction mixture from (r2) with (J) and (K).

The compounds (M) are compounds having one or more isocyanate-reactive groups. They may be, for example, monoalcohols, mercaptans or monoamines having 1 to 20 carbon atoms, preferably monoalcohols, as for example methanol, ethanol, isopropanol, n-propanol, n-butanol, isobutanol, sec-butanol, tent-butanol, ethylene glycol monomethyl ether, ethylene glycol monoethyl ether, diethylene glycol monomethyl ether, diethylene glycol monoethyl ether, 1,3-propanediol monomethyl ether, 1,2-propanediol monoethyl ether, 1,2-propanediol monomethyl ether, n-hexanol, n-heptanol, n-octanol, n-decanol, n-dodecanol, 2-ethylhexanol, cyclopentanol, cyclohexanol, cyclooctanol, cyclododecanol, triethylene glycol monomethyl ether, triethylene glycol monoethyl ether, n-pentanol, stearyl alcohol, cetyl alcohol, lauryl alcohol, cyclopent-2-en-1-ol, cyclopent-3-en-1-ol, cyclohex-2-en-1-ol, allyl alcohol, methylamine, ethylamine, isopropylamine, n-propylamine, n-butylamine, isobutylamine, sec-butylamine, tert-butylamine, n-pentyl amine, n-hexyl amine, n-heptyl amine, n-octyl amine, n-decylamine, n-dodecylamine, 2-ethylhexylamine, stearylamine, cetyl amine, laurylamine, dimethylamine, diethylamine, di-n-propylamine, diisopropylamine, di-n-butylamine, dihexylamine, dioctylamine, ethylmethylamine, isopropylmethylamine, n-butylmethylamine, tent-butylmethylamine, isopropylethylamine, n-butylethylamine, tent-butylethylamine, cyclopentylamine, cyclohexyl amine, cyclooctylamine, cyclododecylamine, morpholine, piperidine, pyrrolidine, N-methylpiperazine, monoethanolamine, monopropanolamine, dipropanolamine, methanethiol, ethanethiol, isopropanethiol, n-propanethiol, n-butanethiol, isobutanethiol, sec-butanethiol or tert-butanethiol.

For each NCO mole equivalent in (J), 0.05-0.6 mol of (K) and 0.2-0 mol of (M) are used, the sum of the amount of (K)+(M) corresponding to the NCO mole equivalents reduced by the molar amount of OH groups and acid groups in the reaction mixture from stage (r2).

The reaction mixture (N) obtainable through reaction with the polyisocyanate (J) generally does not have any significant acid number, has no significant OH number (in each case <5, preferably <3, more preferably <2, and more particularly <1 mg KOH/g), and has an NCO content (calculated as NCO, molar weight 42 g/mol) of <0.5, preferably <0.3, more preferably <0.2, and very preferably <0.1 wt %.

The reaction mixture (N) of the invention, obtainable accordingly, can be used for radiation-curable coating systems or varnishes, which in addition to the reaction mixture (N) of the invention may further comprise reactive diluents (O), photoinitiators (P), and other typical coatings additives (Q).

Reactive diluents—compounds (O)—contemplated include radiation-curable, radically or cationically polymerizable compounds having only one ethylenically unsaturated, copolymerizable group.

Suitable radiation-curable, radically polymerizable reactive diluents are, for example, the triacrylic esters of trimethylolpropane, tetraacrylic esters of pentaerythritol, and the ethoxylated and/or propoxylated derivatives thereof, diacrylic esters of dipropylene glycol, tripropylene glycol, diethylene glycol, 1,2-ethanediol, 1,3- or 1,4-butanediol or 1,6-hexanediol.

Mention may further be made of, for example, C₁-C₂₀-alkyl (meth)acrylates, vinylaromatics having up to 20 C atoms.

Preferred (meth)acrylic acid alkyl esters are those with a C₁-C₁₀-alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Vinylaromatic compounds contemplated include, for example, vinyltoluene, α-butylstyrene, 4-n-butylstyrene, 4-n-decylstyrene, and—preferably—styrene.

Photoinitiators (P) which can be used include in principle all photoinitiators known to the skilled person. Examples of those contemplated include mono- or bisacylphosphine oxides such as Irgacure® 819 (bis(2,4,6-trimethylbenzoyl)phenylphosphine oxide), 2,4,6-trimethylbenzoyldiphenylphosphine oxide (Lucirin® TPO), ethyl 2,4,6-trimethylbenzoylphenylphosphinate, benzophenones, hydroxyacetophenones, phenylglyoxylic acid and its derivatives, or mixtures of these photoinitiators. Examples include benzophenone, acetophenone, acetonaphthoquinone, methyl ethyl ketone, valerophenone, hexanophenone, alpha-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, beta-methylanthraquinone, tert-butylanthraquinone, anthraquinonecarboxylic esters, benzaldehyde, alpha-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]-anthracene-7, 12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, 2-amylanthraquinone, and 2,3-butanedione.

Among the stated photoinitiators, phosphine oxides, alpha-hydroxy ketones, and benzophenones are preferred.

Mixtures of different photoinitiators can also be used.

The photoinitiators can be used alone or in combination with a photopolymerization promoter, of the benzoic acid, amine or similar type, for example.

As typical coatings additives (Q) it is possible, for example, to use antioxidants, oxidation inhibitors, stabilizers, activators (accelerators), fillers, pigments, dyes, devolatilizers, gloss agents, antistatic agents, flame retardants, thickeners, thixotropic agents, flow control assistants, binders, antifoams, fragrances, surface-active agents, viscosity modifiers, plastifiers, plasticizers, tackifying resins (tackifiers), complexing agents or compatibility agents (compatibilizers).

It is possible, furthermore, for one or more photochemically and/or thermally activatable initiators to be added, as for example potassium peroxodisulfate, dibenzoyl peroxide, cyclohexanone peroxide, di-tert-butyl peroxide, azobisisobutyronitrile, cyclohexyl sulfonyl acetyl peroxide, diisopropylpercarbonate, tent-butyl peroctoate or benzopinacol, and also, for example, those thermally activatable initiators which have a half-life at 80° C. of more than 100 hours, such as di-tert-butyl peroxide, cumene hydroperoxide, dicumyl peroxide, tert-butyl perbenzoate, silylated pinacols, which are available commercially, for example, under the trade name ADDID 600 from Wacker, or hydroxyl-containing amine N-oxides, such as 2,2,6,6-tetramethylpiperidine N-oxyl, 4-hydroxy-2,2,6,6-tetramethylpiperidine N-oxyl, etc.

Thickeners contemplated include, besides radically (co)polymerized (co)polymers, customary organic and inorganic thickeners such as hydroxymethylcellulose or bentonite.

Complexing agents used may be, for example, ethylenediamineacetic acid and salts thereof, and also β-diketones.

Suitable fillers encompass silicates, examples being silicates obtainable by hydrolysis of silicon tetrachloride, such as Aerosil® from Degussa, siliceous earth, talc, aluminum silicates, magnesium silicates, calcium carbonates, etc.

Suitable stabilizers encompass typical UV absorbers such as oxanilides, triazines, and benzotriazole (the latter available as Tinuvin® products from Ciba-Spezialitätenchemie), and benzophenones. They can be used alone or together with suitable radical scavengers, examples being sterically hindered amines, such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used customarily in amounts of 0.1 to 5.0 wt %, based on the solid components present in the preparation.

Examples of stabilizers suitable additionally are N-oxyls, such as 4-hydroxy-2,2,6,6-tetramethylpiperidine N-oxyl, 4-oxo-2,2,6,6-tetramethylpiperidine N-oxyl, 4-acetoxy-2,2,6,6-tetramethylpiperidine N-oxyl, 2,2,6,6-tetramethylpiperidine N-oxyl, 4,4′,4″-tris(2,2,6,6-tetramethylpiperidine N-oxyl) phosphite or 3-oxo-2,2,5,5-tetramethylpyrrolidine N-oxyl; phenols and naphthols, such as p-aminophenol, p-nitrosophenol, 2-tert-butylphenol, 4-tert-butylphenol, 2,4-di-tert-butylphenol, 2-methyl-4-tert-butylphenol, 4-methyl-2,6-tert-butylphenol (2,6-tert-butyl-p-cresol) or 4-tert-butyl-2,6-dimethylphenol; quinones, such as hydroquinone or hydroquinone monomethyl ether; aromatic amines, such as N,N-diphenylamine, N-nitrosodiphenylamine, and phenylenediamines, such as N,N′-dialkyl-para-phenylenediamine, where the alkyl radicals may be alike or different and may each independently of one another consist of 1 to 4 carbon atoms and be linear or branched; hydroxylamines, such as N,N-diethylhydroxylamine, urea derivatives, such as urea or thiourea, phosphorus-containing compounds, such as triphenylphosphine, triphenyl phosphite or triethyl phosphite; or sulfur-containing compounds, such as diphenyl sulfide or phenothiazine, for example.

Typical compositions of radiation-curable compositions are for example as follows:
N) 40-100 wt %, preferably 50-90, more preferably 60-90, and more particularly 60-80 wt %,
O) 0-60 wt %, preferably 5-50, more preferably 6-40, and more particularly 10-30 wt %,
P) 0-20 wt %, preferably 0.5-15, more preferably 1-10, and more particularly 2-5 wt %, and
Q) 0-50 wt %, preferably 2-40, more preferably 3-30, and more particularly 5-20 wt %,
with the proviso that (N), (O), (P), and (Q) together make 100 wt %.

The radiation-curable urethane (meth)acrylates of the invention are especially suitable for use as or in compositions which can be cured by means of high-energy radiation.

These compositions may be used as or in coating compositions, e.g., paints, printing inks, adhesives, as printing plates, as moldings, or as a casting composition.

Substrates for the coating may be, for example, textile, leather, metal, plastic, glass, wood, paper or cardboard, preferably wood or metal, and more preferably wood.

The substrates are coated according to customary methods known to the skilled person, in which at least one coating composition is applied to the substrate to be coated, in the desired thickness, and any volatile constituents present in the coating composition are removed, optionally with heating. This operation may if desired be repeated one or more times. Application to the substrate may be accomplished in a known way, as for example by spraying, troweling, knife coating, brushing, rolling, roller coating, pouring, laminating, in-mold coating or coextruding. The coating thickness is situated generally in a range from about 3 to 1000 g/m² and preferably 10 to 200 g/m².

A further subject of the invention is a method for coating substrates wherein the coating composition is applied to the substrate and is dried optionally at temperatures of up to 160° C., and the applied coating is cured with electron beams or UV exposure under an oxygen-containing atmosphere or, preferably, under inert gas, and subsequently, optionally, is dried further at temperatures of up to 160° C.

The thermal drying may also be replaced or supplemented by drying by NIR radiation, with NIR radiation here referring to electromagnetic radiation in the wavelength range from 760 nm to 2.5 μm, preferably from 900 to 1500 nm.

Optionally, if two or more coats of the coating material are applied one over another, thermal and/or NIR drying may take place after each coating operation.

Examples of suitable radiation sources for radiation curing are low-pressure, medium-pressure or high-pressure mercury lamps, and also fluorescent tubes, pulsed emitters, metal halide emitters, electronic flash devices, whereby radiation curing without photoinitiator is possible, or excimer emitters. Radiation curing takes place by exposure to high-energy radiation, this being UV radiation or daylight, preferably light in the wavelength range from 200 to 700 nm, or by bombardment with high-energy electrons (electron beams; 150 to 300 keV). In one preferred embodiment, radiation curing takes place using UV light in the wavelength range from 200 to 500 nm and more particularly from 250 to 400 nm. Examples of radiation sources used include high-pressure mercury vapor lamps, lasers, pulsed lamps (flash light), halogen lamps or excimer emitters. The radiation dose normally sufficient for crosslinking in the case of UV curing is in the range from 80 to 3000 mJ/cm². It is of course also possible to use a plurality of radiation sources for the curing, as for example two to four. These sources may also each emit in different wavelength ranges.

Irradiation may optionally also be carried out in the absence of oxygen, under an inert gas atmosphere, for example. Suitable inert gases are preferably nitrogen, noble gases, carbon dioxide, or combustion gases. Furthermore, irradiation may take place with the coating composition covered with transparent media. Transparent media are, for example, polymeric films, glass or liquids, water for example.

A further subject of the invention are radiation-curable coating compositions comprising a radiation-curable urethane (meth)acrylate in accordance with the present invention.

The coating compositions of the invention are suitable for interior or exterior coatings, i.e., those applications where exposure to daylight is involved, preferably on buildings or parts of buildings, interior coatings, road markings, and coatings on vehicles and aircraft. The coating compositions of the invention are employed more particularly as wood varnishes or in wood varnishes for the interior sector, especially as wood flooring varnishes.

A further subject of the invention is the use of the coating compositions of the invention as wood varnishes for the interior sector, especially as wood flooring varnishes.

Percentages used in this specification are based, unless otherwise indicated, on weight percentages.

### EXAMPLES

### Substances Used

Pluriol A18 TERC: Adduct of 15 mol of ethylene oxide per 1 mol of trimethylolpropane acrylate (from BASF SE)

BADGE: Bisphenol A diglycidyl ether (Epikote 828 F, commercial diepoxide from Momentive)

TBABr: Tetra(n-butyl)ammonium bromide (catalyst)

BADGDA: Bisphenol A diglycidyl diacrylate (CAS No. 67952-50-5)

Kerobit: 2,6-Di-Cert-butyl-p-cresol (Kerobit TBK; stabilizer; from BASF)

Hydroxytempo: 4-Hydroxy-TEMPO (stabilizer; from Sigma-Aldrich)

Borchi-Kat 315: Bismuth neodecanoate (bismuth catalyst) (from Borchers OMG Group)

Basonat HI 100: Polyisocyanate based on isocyanurate-modified hexamethylene diisocyanate (from BASF SE)

Standardized sand: For determining the abrasion resistance, standardized sand in the form of granular aluminum oxide was used (Alodur ESK 240, from Taber Industries)

### Methods of Measurement and Testing

As an introductory note, two of the test methods described below, namely “Viscosity” and “Gelling”, characterize the storage stability. The intention ideally, indeed, is firstly that the viscosity of the substances of the invention, i.e., the urethane acrylates, remain unchanged even on months of storage, including in particular an absence of any unwanted increase in viscosity, and secondly that virtually no solid structures are formed, meaning that there are neither to be solid particles formed nor any formation of gel. In the case of systems which are not storage-stable, in contrast, storage is accompanied by incipient self-crosslinking, with adverse consequences for both of the parameters stated, viz. the viscosity and the gelling.

Viscosity: The viscosity of the substances as such was measured using a Brookfield viscometer at 25° C., rate gradient of 1000 s⁻¹, according to DIN EN ISO 3219/A.3. The viscosity is reported in pascal seconds (Pas). In the context of the studies conducted, the viscosity, as set out above, is an indicator of the storage stability. The viscosity was measured first directly after the preparation of the test substances, and then again after storage of the substances at 20° C. for 17 days and for 231 days.

Gelling: Gelling is understood here first to mean that a gel is formed and secondly to mean that small solid particles are visible. It is assessed visually. In the context of the studies conducted, the gelling, as set out above, is an indicator of the storage stability. The parameter of gelling was tested first directly after preparation of the test substances, and then again after storage of the substances at 20° C. for 17 days and for 231 days.

Pendulum damping (PD): The pendulum damping (often also called pendulum hardness) of coatings resulting from application of the test substances to the surfaces of solid substrates and their curing by means of UV radiation, referred to as König pendulum hardness, was measured according to DIN 53157. With this method, the pendulum damping here is reported in swings.

Abrasion resistance: The abrasion is a measure of the strength of a coating. The abrasion resistance was determined in a “Falling Sand Test” as follows, and reported as mg of substance loss per 1000 revolutions:

For the Falling Sand Test, a Taber® Abraser device was used, fitted with a sand dispenser tube. The formulated varnishes (consisting of test substance plus 4% of the photoinitiator Irgacure 500) were applied using a four-way bar applicator to a substrate, in the present case to glass (wet film thickness=200 μm). This was followed by UV curing twice with a CK lamp, 120 W, at 5 m/min, in order to ensure complete curing. After 48-hour conditioning (T=23° C., humidity 50%), the coated glass plate was inserted into the Taber® Abraser device and rotated at a constant speed of 60 revolutions per minute. Through the sand dispenser tube, standardized sand fell at a rate of 20.7 to 21.0 g per minute onto the rotating, coated substrate (=onto the coated glass plate). On the side opposite from the sand dispenser tube, the sand was removed again with a suction system. Abrasion took place through two leather rollers, which worked the sand into the coated substrate ahead of the suction system and thus resulted in a loss of varnish substance. In order to determine the falling sand performance, the coated substrate was weighed before and after abrasion (after 1000 revolutions) and the difference in mg was calculated. A triplicate determination was carried out.

### Preparation Examples

### Example 1

### (B1)—Inventive

Step (r1): In an apparatus with water separator, 3117 g of Pluriol A18 TERC were esterified with 912 g of acrylic acid and 18.3 g of 96% sulfuric acid (esterification catalyst) in 1350 g of methylcyclohexane (solvent) at an internal temperature of 98 to 105° C. Stabilization took place here with 3.6 g of tert-butyl-p-cresol, 3.6 g of triphenyl phosphite, 3.6 g of hypophosphorous acid, 12.0 g of 4-methoxyphenol, and 0.111 g of phenothiazine. After a 10-hour reaction time, 122.1 g of a 75% strength aqueous TBABr solution were added and the solvent was removed by distillation under reduced pressure (20 mbar) at 112° C. The acid number after the distillation was 45.8 mg KOH/g. The resulting reaction mixture is identified as (R1).

Step (r2): In a three-neck flask, 3370 g of the reaction mixture (R1) obtained in step (r1), which had an acid number 45.8 mg KOH/g, were reacted with 460.56 g of BADGE in the presence of 75.83 g of the catalyst TBABr at 107-108° C. until the acid number (AN) was 3.5. The reaction mixture (R2) formed had the following characteristics: viscosity: 0.53 Pas; iodine color number: 1.4.

Step (r3): 1350 g of the reaction mixture (R2) were then admixed with 150 g of BADGDA and stirred, to form a homogeneous mixture (M1). 350 g of the mixture (M1) were then admixed with 0.39 g of Kerobit, 0.04 g of Hydroxytempo, and 0.35 g of Borchi Kat 315, resulting in the mixture (M2). Added dropwise to this mixture (M2) subsequently at 20° C. were 24.50 g of Basonat HI 100. Heating then took place at an external temperature of 80° C. until the internal temperature was 60°, and, after the internal temperature had reached 60° C., the oil bath was removed and the mixture allowed to cool to room temperature (20° C.).

The urethane acrylate obtained was characterized as follows:

Iodine color number: 1.8; NCO value (free NCO content in %): 0%.

Viscosity (straight after preparation): 3.8 Pas

Viscosity (after storage at 20° C. for 231 days): 3.8 Pas

Gelling (straight after preparation): homogeneous, no gel fractions, no particle formation

Gelling (after storage at 20° C. for 231 days): homogeneous, no gel fractions, no particle formation

The data for viscosity and gelling demonstrate excellent storage stability over the entire period of 231 days (33 weeks).

### Example 2

### (B2)—for Comparison

Like example 1, but catalyst used in step (r3) was 0.35 g of dibutyltin laurate rather than 0.35 g of Borchi Kat 315.

The urethane acrylate obtained was characterized as follows:

Iodine color number: 1.0; NCO value (free NCO content in %): 0%.

Viscosity (straight after preparation): 3.7 Pas

Viscosity (after storage at 20° C. for 17 days): 4.7 Pas

Gelling (straight after preparation): homogeneous, no gel fractions, no particle formation

Gelling (after storage at 20° C. for 17 days): inhomogeneous, particle formation

The data for viscosity and gelling demonstrate that there is no storage stability. After just 17 days (i.e., only a little more than 2 weeks), the substance proved not to be storage-stable.

### Performance Investigations

### Application Example 1

### Determination of Abrasion Resistance Based on the Substance from Example 1

In accordance with the procedure identified above for the Taber® Abraser test, 2 samples were prepared.

50 g of the substance from example 1 were combined with 2 g of Irgacure 500, applied using a four-way bar applicator at 200 μm to glass, and immediately thereafter cured twice with UV light. The properties of the finished film after conditioning were as follows:

Pendulum hardness (according to König, in swings): 46 swings

Abrasion (average from triplicate determination): 15.5 mg

The abrasion resistance was therefore very considerably better than the abrasion resistance according to application example 2 below (comparative example).

### Application Example 2

### Determination of Abrasion Resistance Based on the Substance from Example 2

50 g of the substance from example 2 were combined with 2 g of Irgacure 500, applied using a four-way bar applicator at 200 μm to glass, and immediately thereafter cured twice with UV light. The properties of the finished film after conditioning were as follows:

Pendulum hardness (according to König, in swings): 44 swings

Abrasion (average from triplicate determination): 20.3 mg

1. A radiation-curable urethane (meth)acrylate obtained by:
(r1) partially reacting an alkoxylated polyol (A) with (meth)acrylic acid (B) in the presence of at least one esterification catalyst (C) and at least one polymerization inhibitor (D) and, optionally, a solvent (E) that forms an azeotrope with water,
(o1) optionally removing at least some of the water formed in (r1) from the reaction mixture, it being possible for o1) to take place during and/or after (r1),
(o2) optionally neutralizing the reaction mixture,
(o3) if a solvent (E) has been used, optionally removing this solvent by distillation and/or
(o4) stripping with a gas which is inert under the reaction conditions,
(r2) reacting the reaction mixture obtained after the last of the above reaction steps with a compound (G) containing at least two epoxy groups, optionally in the presence of a catalyst (H), and
(r3) reacting the reaction mixture from (r2) with at least one polyisocyanate (J) and at least one hydroxyalkyl (meth)acrylate (K) and optionally with at least one further compound (M) which contains one or more isocyanate-reactive groups, in the presence of a catalyst (L),
with the proviso that the catalyst (L) used in step (r3) is a bismuth-containing catalyst.

2. The urethane (meth)acrylate according to claim 1, wherein the alkoxylated polyol (A) is an adduct of 1 to 20 mol of ethylene oxide with 1 mol of a polyol selected from the group consisting of trimethylolpropane, trimethylolethane, and pentaerythritol.

3. The urethane (meth)acrylate according to claim 1, wherein the epoxide compound (G) is selected from the group consisting of bisphenol A diglycidyl ether, 1,4-butanediol diglycidyl ether, trimethylolpropane triglycidyl ether, and pentaerythritol tetraglycidyl ether.

4. The urethane (meth)acrylate according to claim 1, wherein the polyisocyanate (J) is selected from the group consisting of 2,4- or 2,6-tolylene diisocyanate and isomer mixtures thereof, hexamethylene diisocyanate, 1,3-bis(isocyanatomethyl)cyclohexane, isophorone diisocyanate, and di(isocyanatocyclohexyl)methane.

5. The urethane (meth)acrylate according to claim 1, wherein the hydroxyalkyl (meth)acrylate (K) is selected from the group consisting of butanediol diglycidyl ether diacrylate and bisphenol A diglycidyl diacrylate.

6. The urethane (meth)acrylate according to claim 1, wherein said bismuth-containing catalyst (L) used is bismuth(III) neodecanoate and/or bismuth(III) 2-ethylhexanoate.

7. A process for preparing a radiation-curable urethane (meth)acrylate by:
(r1) partially reacting an alkoxylated polyol (A) with (meth)acrylic acid (B) in the presence of at least one esterification catalyst (C) and at least one polymerization inhibitor (D) and, optionally, a solvent (E) that forms an azeotrope with water,
(o1) optionally removing at least some of the water formed in (r1) from the reaction mixture, it being possible for o1) to take place during and/or after (r1),
(o2) optionally neutralizing the reaction mixture,
(o3) if a solvent (E) has been used, optionally removing this solvent by distillation and/or
(o4) stripping with a gas which is inert under the reaction conditions,
(r2) reacting the reaction mixture obtained after the last of the above reaction steps with a compound (G) containing at least two epoxy groups, optionally in the presence of a catalyst (H), and
(r3) reacting the reaction mixture from (r2) with at least one polyisocyanate (J) and at least one hydroxyalkyl (meth)acrylate (K) and optionally with at least one further compound (M) which contains one or more isocyanate-reactive groups, in the presence of a catalyst (L),
with the proviso that the catalyst (L) used in step (r3) is a bismuth-containing catalyst.

8. The process according to claim 7, wherein the alkoxylated polyol (A) is an adduct of 1 to 20 mol of ethylene oxide with 1 mol of a polyol selected from the group consisting of trimethylolpropane, trimethylolethane, and pentaerythritol.

9. The process according to claim 7, wherein the epoxide compound (G) is selected from the group consisting of bisphenol A diglycidyl ether, 1,4-butanediol diglycidyl ether, trimethylolpropane triglycidyl ether, and pentaerythritol tetraglycidyl ether.

10. The process according to claim 7, wherein the polyisocyanate (J) is selected from the group consisting of 2,4- or 2,6-tolylene diisocyanate and isomer mixtures thereof, hexamethylene diisocyanate, 1,3-bis(isocyanatomethyl)cyclohexane, isophorone diisocyanate, and di(isocyanatocyclohexyl)methane.

11. The process according to claim 7, wherein the hydroxyalkyl (meth)acrylate (K) is selected from the group consisting of butanediol diglycidyl ether diacrylate and bisphenol A diglycidyl diacrylate.

12. The process according to any of claim 7, wherein said bismuth-containing catalyst (L) used is bismuth(III) neodecanoate and/or bismuth(III) 2-ethylhexanoate.

13. A radiation-curable coating composition comprising a radiation-curable urethane (meth)acrylate according to claim 1.

14. The coating composition according to claim 13 for use as a wood varnish for the interior sector.
